(19) United States
(12) Patent Application Publication
(10) Pub. No.: US 2026/0170399 A1
(43) Pub. Date: Jun. 18, 2026

(54) METHOD OF GENERATING AN OPTIMAL CELL ARCHITECTURE MACHINE LEARNING MODEL

(71) Applicant: Fortinet, Inc., Sunnyvale, CA (US)

(72) Inventor: Sameer Khanna, Sunnyvale, CA (US)

(73) Assignee: Fortinet, Inc., Sunnyvale, CA (US)

(21) Appl. No.: 18/980,273

(22) Filed: Dec. 13, 2024

(51) Int. Cl. G06N 20/00; G06N 3/02

(52) U.S. Cl. CPC G06N 20/00; G06N 3/02

(57) ABSTRACT

A machine learning (ML) model architect identifies a problem space for a ML model. The ML model architect then selects a cell architecture skeleton. The ML model architecture defines a set of operations for the cell architecture skeleton. An overparameterized model may be built based at least in part on the cell architecture skeleton and the set of operations for the problem space. The overparameterized model may be reduced to generate a reduced model. The reduced model may be trained using a training dataset to produce a trained, reduced model. Suboptimal operations may be pruned from the trained reduced model to produce a pruned reduced model. Reverse reduction processing may then be performed on the pruned reduced model to generate an optimal cell architecture model for the identified problem space.

### BACKGROUND

Various embodiments of the present disclosure generally relate to machine learning (ML) in computing systems. In particular, embodiments relate to generating an optimal cell architecture ML model for use in a computing system.

ML model architecture search (MAS) is a process designed to find optimal neural network architectures for a given task. This process, pivotal for advancing the state of the art in various ML computing applications, often involves searching through a vast space of possible ML model architectures, making computational complexity a critical factor to consider. The search space in MAS can be enormous due to the combinatorial nature of neural network components such as the number of layers, types of layers (e.g., convolutional, recurrent, fully connected), layer parameters (e.g., kernel size, stride), and connections between layers. For instance, a modest search space with 10 layers, each having 10 possible configurations, results in 10\hat{ }10 possible architectures. The sheer number of combinations implies a need for efficient search strategies to manage computational resources effectively. Evaluating a candidate architecture typically involves training the network and validating its performance on a large dataset, which is computationally expensive. Training deep neural networks can take hours to days, even on powerful graphics processing units (GPUs). Consequently, evaluating millions of candidate architectures for a new ML model within a reasonable timeframe becomes impractical.

### SUMMARY

Systems and methods are described for improving ML technology in the context of generating ML models of neural network architectures in computing systems. The present disclosure describes methods for reducing the computation costs of searching possible neural network architectures by training multiple ML model architectures at the same time via a reversible model reduction strategy. In experiments analyzing the application of the technology disclosed herein for the example problem space of quantized training, training time was decreased by up to 1.47× and performance scores were achieved with statistically insignificant differences from full precision methodologies. The technology disclosed herein can help expand model search to a wide array of applications, which in turn can improve downstream task accuracy.

In an embodiment, a ML model architect identifies a problem space for a ML model. The ML model architect then selects a cell architecture skeleton. The ML model architecture defines a set of operations for the cell architecture skeleton. An overparameterized model may be built based at least in part on the cell architecture skeleton and the set of operations for the problem space. The overparameterized model may be reduced to generate a reduced model. The reduced model may be trained using a training dataset to produce a trained, reduced model. Suboptimal operations may be pruned from the trained reduced model to produce a pruned reduced model. Reverse reduction processing may then be performed on the pruned reduced model to generate an optimal cell architecture model for the identified problem space.

Other features of embodiments of the present disclosure will be apparent from accompanying drawings and detailed description that follows.

### BRIEF DESCRIPTION OF THE DRAWINGS

In the FIGURES, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a model generator in a computing environment according to an embodiment of the present disclosure.

FIG. 2 illustrates a process for generating an optimal cell architecture model according to an embodiment of the present disclosure.

FIG. 3 illustrates an example of model generation processing according to an embodiment of the present disclosure.

FIG. 4 illustrates an example of reduction processing according to an embodiment of the present disclosure.

FIG. 5 illustrates an example computing system in which or with which embodiments of the present disclosure may be utilized.

### DETAILED DESCRIPTION

In the following description, numerous specific details are set forth to provide a thorough understanding of embodiments of the present disclosure. It will be apparent, however, to one skilled in the art that embodiments of the present disclosure may be practiced without some of these specific details. In other instances, well-known structures and devices are shown in block diagram form.

Brief definitions of terms used throughout this application are given below.

A “computer”, “computer system” or “computing system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” or a “computing system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform one or more network functions. Other network devices may also include custom hardware (e.g., one or more custom (ASICs)). Based upon the disclosure provided herein, one of ordinary skill in the art will recognize a variety of network appliances that may be used in relation to different embodiments.

As used herein, the phrases “network path”, “communication path”, or “network communication path” generally refer to a path whereby information may be sent from one end and received on the other. In some embodiments, such paths are referred to commonly as tunnels which are configured and provisioned as is known in the art. Such paths may traverse, but are not limited to traversing, wired or wireless communication links, wide area network (WAN) communication links, local area network (LAN) communication links, and/or combinations of the aforementioned. Based upon the disclosure provided herein, one of ordinary skill in the art will recognize a variety of communication paths and/or combinations of communication paths that may be used in relation to different embodiments.

The phrases “processing resource” and “processing circuitry” are used in their broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

One hurdle arising from tackling the neural network architecture search optimization task is the vast search space from which optimal models may be derived. This can lead to convergence issues, wasted time spent searching suboptimal network configurations, and brittle networks that do not generalize well. To combat these issues, the present disclosure operates on cell-based architectures. A cell-based architecture is a type of neural network that uses repeating small sub-networks called cells to reduce the search space for neural networks. When determining the optimal cell architecture, cells may be stacked into a deeper network on a backbone network. The backbone network is an overall shape the network takes and is determined by the current state of the art in the given problem space being considered. In other words, the architecture of the cell is shared by the entire network.

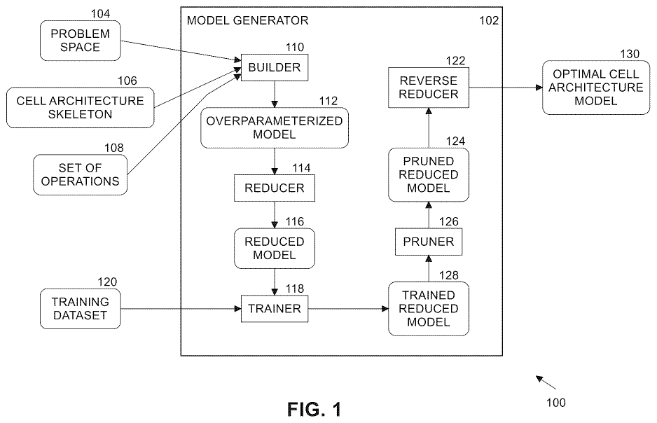

FIG. 1 illustrates a model generator 102 in a computing environment 100 according to an embodiment of the present disclosure. Model generator 102 may be implemented in software, hardware, or a combination of software and hardware in any computing system. Generally, model generator 102 reads a pre-defined cell architecture skeleton 106 and a defined set of operations 108 for an identified problem space 104 and generates an optimal cell architecture model 130.

First, a valid problem space 104 is identified. The problem space may be any problem that a ML model can reasonably be expected to work in defined by someone who is an expert in the field. For example, a human ML model architect may define the problem space for generation of a ML model to be applied to the problem space. Problem spaces can include image segmentation, image classification, generation-related tasks, translation, anomaly detection, among a variety of others. Next, the ML model architect selects a cell architecture skeleton 106 to be used as a baseline for the ML model to be generated by model generator 102 for the identified problem space 104. As used herein, a cell architecture skeleton 106 is the overall shape of the model where cells, which are repeating subnetwork architectures, can be slotted in to form a complete model. For example, the ML model architect may collect multiple cell architecture skeletons of ML model designs made by others for application to the identified problem space 104 and/or newly define new cell architecture skeletons for application to the identified problem space in a database. The ML model architect may then select the cell architecture skeleton 106 he or she believes to be the most appropriate for the problem space 104. As one example of potentially many, if the ML model's purpose is to perform image segmentation processing, then the ML model architect may choose a U-Net like architecture, as U-Nets are commonly used in the image segmentation problem space. Notably, the selected cell architecture skeleton 106 must be modular in nature in order to reduce the overall search space to a more manageable form. The ML model to be generated by model generator 102 will consist of multiples of the same module to improve model search efficiency and reduce the potential search space.

In addition to selecting an effective cell architecture skeleton 106, the ML model architect also defines a set of operations 108 for the selected cell architecture skeleton 106. The set of operations 108 includes the options of operations to be searched among each node within a module of a model based on the cell architecture skeleton. In a cell-based architecture, the architecture skeleton defines the overall structure and communication between cells, which are modular units responsible for specific functions. Each module contains nodes, the internal components that perform the detailed processing. The skeleton governs inter-cell communication, while modules and nodes handle local functionality.

In an embodiment, builder 110 within model generator 102 builds an overparameterized model 112 based at least in part on the problem space 104, cell architecture skeleton 106 and set of operations 108. Using the cell architecture skeleton 106 (defined in a modular nature), all possible operations from the set of operations 108 are configured between each node in the overparameterized model 112. This enables model generator 102 to evaluate the effectiveness of all possible operations for each specific node in a model. Reducer 114 of model generator 102 performs reduction processing on overparameterized model 112 to generate reduced model 116. Reducer 114 may perform any reversible function that helps simplify training in some manner or form. An example (one of potentially many) of this is quantization, wherein the reversible function includes the process of reducing the precision used. This is reversible since the precision may be simply increased to reverse the reversible function performed by reducer 114. The reduction need not be exactly invertible; the reduction simply must be reversible, resulting in a substantially equivalent form to the starting form.

Next, trainer 118 of model generator 102 trains reduced model 116 based at least in part on training data set 120 to produce trained reduced model 128 (e.g., wherein reduced model 116 is smaller than overparameterized model 112). Training dataset 120 should be large and diverse in nature while also being applicable to the identified problem space 104. One example (of potentially many) is a natural image segmentation dataset when image segmentation is the problem space. Since training is performed on reduced model 116, training time is reduced as compared to training overparameterized model 112. Once training is complete, pruner 126 of model generator 102 removes all but one or zero of the (sub-optimal) operations between any two given nodes in a module of trained reduced model 128 to produce a pruned reduced model 124. Reduction can be done based on a number of potential criteria, including energy efficiency of the operation, the effect the operation has on the final model accuracy, or how fast the operation is to compute, among others. One example (of potentially many) methods to do this is by simply taking the “argmax” of the weight values used to compare the operations between any given nodes.

Finally, reverse reducer 122 applies reverse reducer processing (that is, the reverse of reducer processing performed by reducer 114) to pruned reduced model 124 to generate optimal cell architecture model 130. Optimal cell architecture model 130 may be applied to any task for which another ML model for the problem space may be used (or associated). Some examples include fine-tuning the model for a downstream task, direct usage on the chosen problem space (e.g., by training the optimal cell architecture model 130 on training dataset 120 or other training dataset and then using the trained model for inference processing, utilization for knowledge distillation, used for contrastive learning, or other tasks.

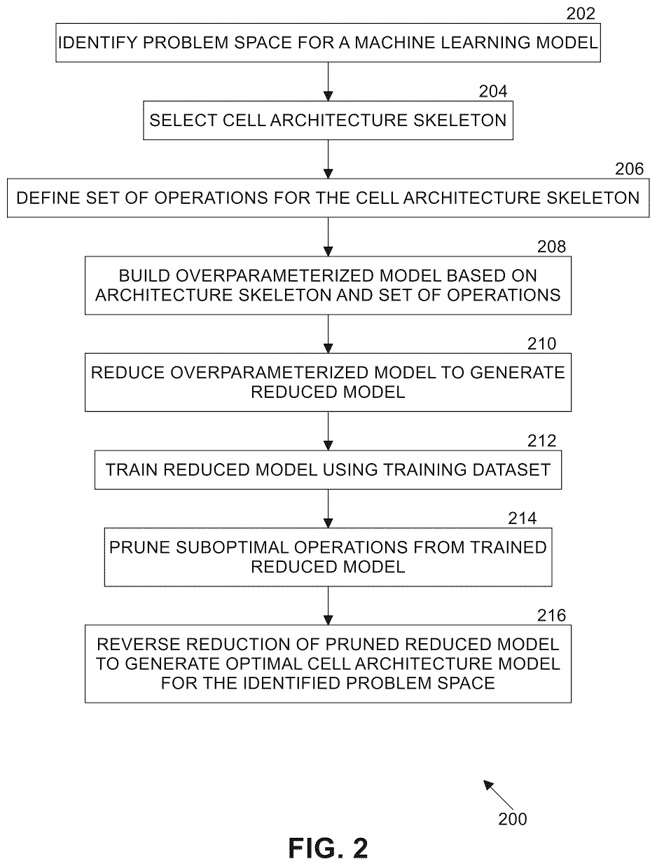

FIG. 2 illustrates a process 200 for generating optimal cell architecture model 130 according to an embodiment of the present disclosure. At block 202, a ML model architect identifies a problem space 104 for a machine learning (ML) model. At block 204, the ML model architect selects a cell architecture skeleton 106. At block 206, the ML model architecture defines a set of operations 108 for the cell architecture skeleton 106. At block 208, builder 110 of model generator 102 builds overparameterized model 112 based at least in part on cell architecture skeleton 106 and set of operations 108 for problem space 104. At block 210, reducer 114 of model generator 102 reduces overparameterized model 112 to generate reduced model 116. At block 212, trainer 118 of model generator 102 trains reduced model 116 using training dataset 120 to produce trained reduced model 128. At block 214, pruner 126 of model generator 102 prunes suboptimal operations from trained reduced model 128 to produce pruned reduced model 124. At block 216, reverse reducer 122 of model generator 102 performs reverses reduction processing of pruned reduced model 124 to generate optimal cell architecture model 130 for the identified problem space 104.

In an example discussed below, the technology disclosed herein may be applied to the problem space of computer vision.

Table 1 details an example of primitive operations used for searching cells for an example computer vision problem space. Note that the size of all convolutional operations of the set of operations 108 including the cweight operation is 3×3 and the pooling operation is 2×2.

TABLE 1

| Down POs | Up POs | Normal POS |
|---|---|---|
| max pooling | up cweight | identity |
| down cweight | up depth conv | cweight |
| down dilation conv | up conv | dilation conv |
| down depth conv | up dialtion conv | depth conv |
| down conv | | conv |

There are two types of cell architectures that can be searched for in an example computer vision application: down-sampling supercell and up-sampling supercell. For both cells, the input nodes are defined as the outputs of the previous two layers. All operations adjacent to the input nodes are either from the down-sampling primitive operation set or from the up-sampling primitive operation set. The total number of edges between intermediate and input nodes is defined in Equation 1 below.

$$E = 2 M + \frac{M ( M - 1 )}{2} \qquad Equation 1$$

Where M is the number of intermediate nodes, and E is the number of edges.

On contracting steps (e.g., reducing) (for certain problem spaces), L_1 cells are linked together to form a representation of the semantic context information, producing a smaller probability map. On the expanding steps (e.g., reverse reducing) (for certain problem spaces), the same number of cells work to restore spatial information with the intent of keeping consistency with the input image. During search, one may start with an over-parameterized cell architecture C(e_1, . . . , e_E) where e_i represents an edge in the cell architecture directed acyclic graph (DAG). Let O=o_i be one of the primitive operation sets defined in Table 1 above. Rather than having every edge associated with a definite operation, each edge is instead a mixed operation (MixO) with parallel paths for each operation in the given set.

Thus, the over-parameterized cell architecture can be expressed as C (e_1=MixO_1, . . . , e_E=MixO_E). The output of a mixed operation is shown in Equation 2 below.

$$MixO ( x ) = {\sum }_{i = 1}^{N} \text{?} ( x ) \qquad Equation 2$$

$$\text{?} \text{indicates text missing or illegible when filed}$$

Here, N corresponds to the number of primitive operations in the given set. w_i indicates the weight of o_i, the i-th operation in the given primitive operation set. Like in DARTs, w_i is calculated by applying softmax to N real-valued architecture parameters \alpha_i as shown in Equation 3 below. The initial value of each alpha_i is 1/N.

$${w}_{i} = \frac{\text{?}}{{\sum }_{j = 1}^{N} \text{?}} \qquad Equation 3$$

$$\text{?} \text{indicates text missing or illegible when filed}$$

One goal is to utilize quantization of training to expedite the convergence process while maintaining model accuracy. It is hypothesized that reducing precision could potentially accelerate training times without significant loss in performance. To investigate this, experiments were performed with three distinct training methodologies: Quantization-Aware Training, Mixed Precision Training, and Low-bit Training.

Quantization was focused on for the “model reduction” strategy due to it being an area of immense research focus currently. GPUs are expected to only become more optimized at using quantization currently. However, the idea and methodology are more generalizable: if a better form of reversible model reduction processing gets proposed in the future, the technology disclosed herein can be utilized in tandem with the new technology.

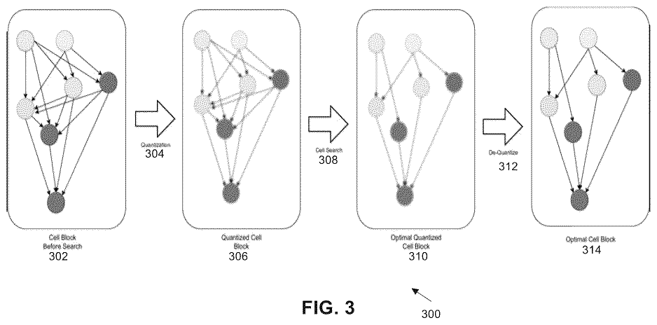

FIG. 3 illustrates an example of model generation processing according to an embodiment of the present disclosure. FIG. 3 shows how the technology disclosed herein may be applied with quantization as the reversible reduction strategy.

Quantization-Aware Training (QAT) is a technique that addresses this issue by incorporating quantization effects into the training process. This allows the model to adapt to lower precision representations while minimizing accuracy degradation.

During QAT, the training workflow is augmented with simulated quantization steps. This typically involves inserting quantization 304 and de-quantization (Q/DQ) 312 nodes into the model graph. Quantization 304 may be applied to cell block before search 302 to generate quantized cell block 306. Cell search 308 operation may be performed on quantized cell block 306 to generate optimal quantized cell block 310. Optimal quantized cell block 310 may then be de-quantized 312 to produce optimal cell block 314.

These nodes emulate the scaling, clipping, and rounding operations that occur during inference with quantized weights and activations. The Q/DQ nodes introduce a quantization loss that is added to the overall training loss function. The model is then trained to minimize this combined loss, leading to a model that is more robust to quantization effects.

QAT offers several advantages. QAT allows the model to learn how to compensate for quantization errors during training. This typically results in higher accuracy. Additionally, quantization reduces the bit-width of weights and activations, leading to smaller model footprints and faster inference on devices with limited memory and computational power.

For QAT, uniform affine quantization may be used. In uniform affine quantization, each element in a tensor is scaled and shifted to a lower precision representation using a single scale factor and zero point.

Mixed precision training is a promising approach in deep learning that offers significant computational speedup by leveraging half-precision format for operations while storing minimal information in single precision to preserve crucial details within the network. This strategy involves two key steps: firstly, adapting the model to utilize 16-bit data types where suitable, and secondly, integrating loss scaling to maintain the integrity of small gradient values.

By employing half-precision floating point format, which utilizes 16 bits compared to the standard 32 bits for single precision, mixed precision training optimizes memory usage, thereby enabling the training of larger models or facilitating training with larger mini-batches. This reduction in memory requirements not only allows for greater model complexity but also minimizes the time spent in memory-limited layers, consequently enhancing overall execution time efficiency. Additionally, GPUs from Nvidia Corporation, which are commonly used in deep learning tasks, exhibit up to 8× more half precision arithmetic throughput when compared to single-precision operations, effectively accelerating computations in math-limited layers and further optimizing training performance.

In one scenario, a bfloat16 may be employed as the reduced precision format. Unlike float16 (fp16), which uses the same number of bits (16) but dedicates all bits to the mantissa, bfloat16 leverages a custom 16-bit floating-point representation. It retains the same exponent width (8 bits) as single precision float32 (fp32), enabling it to represent a similar dynamic range of numbers. However, bfloat16 dedicates the remaining bits to the mantissa, offering a compromise between the dynamic range of fp32 and the potential efficiency gains of fp16. This configuration allows bfloat16 to maintain a sufficient level of precision for most deep learning workloads while enabling faster computations and reduced memory footprint compared to fp32. This characteristic makes bfloat16 particularly suitable for mixed precision training, where the benefits of lower precision can be exploited without sacrificing significant accuracy.

A recent advancement is the development of 8-bit optimizers that utilize lower precision representations for the optimizer states. This approach leverages block-wise quantization, a technique that addresses the challenges associated with directly quantizing the entire optimizer state.

Block-wise quantization divides the optimizer state tensor (e.g., gradients) into smaller blocks. Each block is then independently quantized. This approach offers several advantages.

First, large outliers within the optimizer state can have a significant impact on the quantization error when using full tensor quantization. By dividing the data into smaller blocks, outliers are more likely to be isolated within individual blocks, minimizing their influence on the overall quantization error.

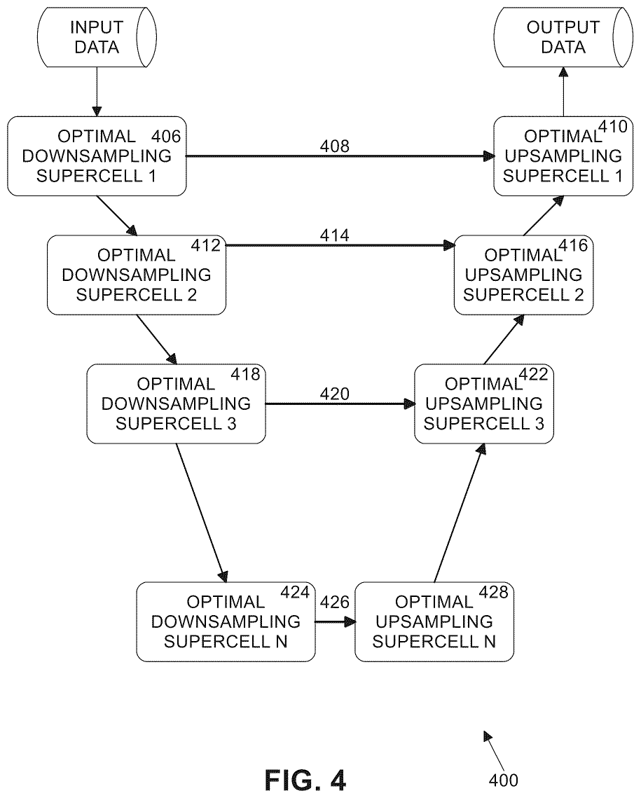

Second, block-wise quantization allows for a finer-grained distribution of quantization levels within each block, leading to improved precision compared to full tensor quantization. Finally, the independent nature of block-wise quantization enables parallel processing of individual blocks during the quantization and de-quantization steps. This can significantly improve the efficiency of the optimization process. For 8-bit training, uniform affine quantization may be used. Once the optimal cell is found, the full version of the cell may be used on a downstream task as shown in FIG. 4.

FIG. 4 illustrates an example of reduction processing according to an embodiment of the present disclosure. This model corresponds to an example model designed for image segmentation. The architecture layout shown here is in similar shape and form to a U-Net, the most popular architecture used for the image segmentation task. Like a U-Net, this example architecture uses down-sampling modules in 406, 412, 418, and 424 as well as up-sampling cells in 428, 422, 416, and 410, as well as transforms 408, 414, 420 and 426. It is important to note that two different modules are defined here as they are designed for different tasks within the architecture. The number of different modules to be searched is determined by the skeleton chosen.

The above description is an example configuration for a particular problem space. Different configurations (also known as model skeletons) can be used for different problem spaces.

The technology of the computing system described herein provides at least several advantages and technical improvements over existing computer systems. Embodiments developed in this manner are designed with tight integration with the exact problem they are attempting to solve, allowing for higher accuracy in predictions. This reduction paradigm enables one to obtain the benefits of such a search with fewer costs in terms of time and money, allowing for such search to be used for a wider range of potential applications.

While in the context of the example described with reference to the flow diagrams of this disclosure, a number of enumerated blocks are included, it is to be understood that examples may include additional blocks before, after, and/or in between the enumerated blocks. Similarly, in some examples, one or more of the enumerated blocks may be omitted and/or performed in a different order.

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a tangible non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or general-purpose computer hardware to execute the code contained therein. An apparatus for practicing various embodiments of the present disclosure may involve one or more computer systems (e.g., physical and/or virtual servers, physical and/or virtual network security appliances) (or one or more processors within a single computer system) and storage systems containing or having network access to computer program(s) coded in accordance with various methods described herein, and the method steps associated with embodiments of the present disclosure may be accomplished by modules, routines, subroutines, or subparts of a computer program product.

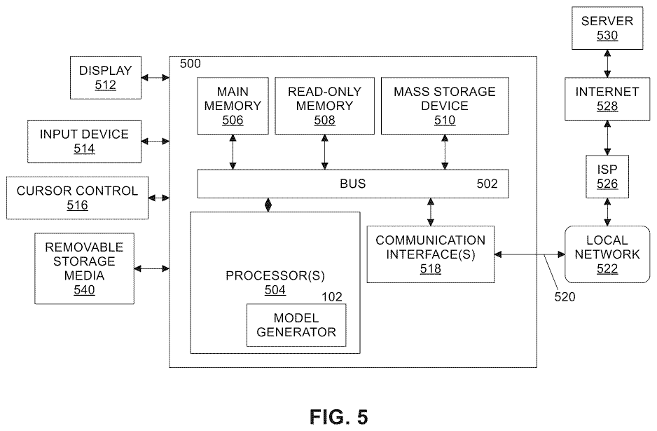

FIG. 5 illustrates an example computing system in which or with which embodiments of the present disclosure may be utilized. FIG. 5 shows a block diagram that illustrates a computing system 500 in which or with which an embodiment of the present disclosure may be implemented. Computing system 500 may be representative of a computer server (e.g., a cloud server in a cloud computing environment) or client computing system on which model generator 102 is running. Notably, components of computing system 500 described herein are meant only to exemplify various possibilities. In no way should the example computing system 500 limit the scope of the present disclosure. In the context of the present example, computing system 500 includes a bus 502 or other communication mechanism for communicating information, and one or more processing resources (e.g., one or more hardware processors 504) coupled with bus 502 for processing information. Hardware processors 504 may include, for example, one or more general purpose microprocessors available from one or more current or future microprocessor manufactures (e.g., Intel Corporation, Advanced Micro Devices, Inc., and/or the like) and/or one or more special purpose processors (e.g., graphics processing units (GPUs), network processors (NPs), and/or accelerators or co-processors). In some examples, one or more processing resources may be part of an application specific integrated circuit (ASIC)-based security processing unit (e.g., the FORTISP family of security processing units available from Fortinet, Inc. of Sunnyvale, CA) or a network device.

Computing system 500 also includes a main memory 506, such as a machine-readable random-access memory (RAM) or other dynamic storage device, coupled to bus 502 for storing information and instructions (e.g., model generator 102) to be executed by processor(s) 504. Main memory 506 also may be used for storing temporary variables or other intermediate information during execution of instructions to be executed by processor(s) 504. Such instructions, when stored in non-transitory storage media accessible to processor(s) 504, render computing system 500 into a special-purpose machine that is customized to perform the operations specified in the instructions.

Computing system 500 further includes a read only memory (ROM) 508 or other static storage device coupled to bus 502 for storing static information and instructions (e.g., model generator 102) for processor(s) 504. A storage device 510, e.g., a magnetic disk, optical disk or flash disk (made of flash memory chips), is provided and coupled to bus 502 for storing information and instructions.

In an embodiment, model generator 102 may be included in an operating system (OS) (such as FortiOS available from Fortinet, Inc.), a network device, or a network security appliance (NSA), or may be implemented as a standalone software or hardware module in a computing system. For example, model generator 102 may be included in any virtual machine that performs processing of data for security and/or computer networking purposes. Such purposes may include, but are not limited to, authentication, next-generation firewall protection, anti-trojan scanning, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Security (IPSec), TLS, SSL), application control, Voice over Internet Protocol (VOIP) support, Virtual Private Networking (VPN), data leak prevention (DLP), antispam, antispyware, logging, reputation-based protections, event correlation, network access control, vulnerability management, and the like. Based upon the disclosure provided herein, one of ordinary skill in the art will recognize a variety of ML model generation processes that may be implemented in accordance with different embodiments. In some embodiments, model generator 102 may be a virtual implementation of a known network security appliance including, but not limited to, network gateways, virtual private network (VPN) appliances/gateways, unified threat management (UTM) appliances (e.g., the FORTIGATE family of network security appliances available from Fortinet, Inc.), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

Computing system 500 may be coupled via bus 502 to a display 512, e.g., a cathode ray tube (CRT), Liquid Crystal Display (LCD), Organic Light-Emitting Diode Display (OLED), Digital Light Processing Display (DLP) or the like, for displaying information to a computer user. An input device 514, including alphanumeric and other keys, is coupled to bus 502 for communicating information and command selections to processor(s) 504. Another type of user input device is cursor control 516, such as a mouse, a trackball, a trackpad, or cursor direction keys for communicating direction information and command selections to processor(s) 504 and for controlling cursor movement on display 512. The input device typically has two degrees of freedom in two axes, a first axis (e.g., x) and a second axis (e.g., y), that allows the device to specify positions in a plane.

Removable storage media 540 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computing system 500 may implement the techniques described herein using customized hard-wired logic, one or more ASICs or field programmable gate arrays (FPGAs), firmware or program logic which in combination with the computer system causes or programs computing system 500 to be a special-purpose machine. According to one embodiment, the techniques herein are performed by computing system 500 in response to processor(s) 2004 executing one or more sequences of one or more instructions (e.g., model generator 102) contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “storage media” as used herein refers to any non-transitory machine-readable media that store data or instructions that cause a machine to operate in a specific fashion. Such storage media may comprise non-volatile media or volatile media. Non-volatile media includes, for example, optical, magnetic or flash disks, such as storage device 510. Volatile media includes dynamic memory, such as main memory 506. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infrared data communications.

Various forms of media may be involved in carrying one or more sequences of one or more instructions to processor(s) 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor(s) 504 retrieve and execute the instructions. The instructions received by main memory 506 may optionally be stored on storage device 510 either before or after execution by processor(s) 504.

Computing system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic or optical signals that carry digital data streams. The signals through the networks and the signals on network link 520 and through communication interface 518, which carry the digital data to and from computing system 500, are example forms of transmission media.

Computing system 500 can send messages and receive data, including program code, through the network(s), network link 520 and communication interface 518. In the Internet example, server 530 might transmit a requested code for an application program through Internet 528, ISP 526, local network 522 and communication interface 518. The received code may be executed by processor(s) 504 as it is received, or stored in storage device 510, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
building, by processing circuitry, an overparameterized machine learning model based at least in part on a cell architecture skeleton and a set of operations for a problem space;
reducing, by the processing circuitry, the overparameterized machine learning model to generate a reduced machine learning model;
training, by the processing circuitry, the reduced machine learning model using a training dataset to produce a trained, reduced machine learning model;
pruning, by the processing circuitry, suboptimal operations from the trained, reduced machine learning model to produce a pruned, reduced machine learning model; and
performing, by the processing circuitry, reverse reduction processing of the pruned, reduced machine learning model to generate an optimal cell architecture machine learning model for the problem space.

2. The method of claim 1, wherein the cell architecture skeleton comprises a neural network using repeating cells, wherein cells comprise sub-networks of the neural network.

3. The method of claim 1, wherein the cell architecture skeleton comprises a baseline machine learning model for the problem space.

4. The method of claim 1, wherein the cell architecture skeleton comprises a modular machine learning model.

5. The method of claim 1, wherein the set of operations comprise operations to be searched among each node within a module of the overparameterized machine learning model.

6. The method of claim 1, wherein the overparameterized machine learning module comprises all possible operations from the set of operations configured between nodes of the overparameterized machine learning model.

7. The method of claim 1, comprising generating the reduced machine learning model using a reversible function to simplify training of the reduced machine learning model.

8. The method of claim 1, wherein the reduced machine learning model is smaller than the overparameterized machine learning model.

9. The method of claim 1, wherein pruning comprises removing all but one or zero of the suboptimal operations between any two nodes in a module of the trained, reduced machine learning model.

10. The method of claim 1, comprising applying the optimal cell architecture machine learning model to a task associated with the problem space.

11. A non-transitory, machine-readable medium storing instructions, which when executed by processing circuitry, cause the processing circuitry to:
build an overparameterized machine learning model based at least in part on a cell architecture skeleton and a set of operations for a problem space;
reducing the overparameterized machine learning model to generate a reduced machine learning model;
train the reduced machine learning model using a training dataset to produce a trained, reduced machine learning model;
prune suboptimal operations from the trained, reduced machine learning model to produce a pruned, reduced machine learning model; and
perform reverse reduction processing of the pruned, reduced machine learning model to generate an optimal cell architecture machine learning model for the problem space.

12. The non-transitory, machine-readable medium of claim 11, wherein the cell architecture skeleton comprises a neural network using repeating cells, wherein cells comprise sub-networks of the neural network.

13. The non-transitory, machine-readable medium of claim 11, wherein the cell architecture skeleton comprises a baseline machine learning model for the problem space.

14. The non-transitory, machine-readable medium of claim 11, wherein the cell architecture skeleton comprises a modular machine learning model.

15. The non-transitory, machine-readable medium of claim 11, wherein the set of operations comprise operations to be searched among each node within a module of the overparameterized machine learning model.

16. The non-transitory, machine-readable medium of claim 11, wherein the overparameterized machine learning module comprises all possible operations from the set of operations configured between nodes of the overparameterized machine learning model.

17. An apparatus comprising:
processing circuitry; and
instructions that when executed by the processing circuitry cause the apparatus to:
build an overparameterized machine learning model based at least in part on a cell architecture skeleton and a set of operations for a problem space;
reducing the overparameterized machine learning model to generate a reduced machine learning model;
train the reduced machine learning model using a training dataset to produce a trained, reduced machine learning model;
prune suboptimal operations from the trained, reduced machine learning model to produce a pruned, reduced machine learning model; and
perform reverse reduction processing of the pruned, reduced machine learning model to generate an optimal cell architecture machine learning model for the problem space.

18. The apparatus of claim 17, comprising instructions that when executed by the processing circuitry to generate the reduced machine learning model using a reversible function to simplify training of the reduced machine learning model.

19. The apparatus of claim 17, wherein the reduced machine learning model is smaller than the overparameterized machine learning model.

20. The apparatus of claim 17, wherein pruning comprises removing all but one or zero of the suboptimal operations between any two nodes in a module of the trained, reduced machine learning model.
